(19) United States
(12) Patent Application Publication
(10) Pub. No.: US 2015/0160452 A1
(43) Pub. Date: Jun. 11, 2015

(54) OPTICAL ELEMENT AND IMAGE DISPLAY DEVICE

(71) Applicant: FUJIFILM CORPORATION, Tokyo (JP)

(72) Inventors: Takashi ARIDOMI, Shizuoka-ken (JP); Yuuichi FUKUSHIGE, Shizuoka-ken (JP); Satoshi HIGUCHI, Shizuoka-ken (JP)

(21) Appl. No.: 14/624,585

(22) Filed: Feb. 18, 2015

Related U.S. Application Data
(63) Continuation of application No. PCT/JP2013/071884, filed on Aug. 13, 2013.

(30) Foreign Application Priority Data
Sep. 7, 2012 (JP) 2012-197950

(51) Int. Cl. G02B 26/00; C08G 77/24; C08G 77/26; G02B 1/06; C08G 77/04

(52) U.S. Cl. CPC G02B 26/005; G02B 1/06; C08G 77/04; C08G 77/26; C08G 77/24

(57) ABSTRACT

An optical element including a cell a cell, the cell including: a first substrate, at least a portion of at least one surface of the first substrate being electroconductive; a second substrate disposed so as to face the electroconductive surface of the first substrate; an electrically non-conductive oil and an electroconductive hydrophilic liquid that are provided between the electroconductive surface of the first substrate and the second substrate; and a hydrophobic insulating film that is provided at at least a portion of the electroconductive surface side of the first substrate, that contacts the oil, and that includes a crosslinked structure derived from a siloxane compound having an unsaturated double bond, the profile of an interface between the oil and the hydrophilic liquid changing according to a voltage applied across the hydrophilic liquid and the electroconductive surface of the first substrate.

### CROSS-REFERENCE TO RELATED APPLICATIONS

This application is a continuation application of International Application No. PCT/JP2013/071884, filed Aug. 13, 2013, which is incorporated herein by reference. Further, this application claims priority from Japanese Patent Application No. 2012-197950, filed Sep. 7, 2012, which is incorporated herein by reference.

### TECHNICAL FIELD

The present invention relates to an optical element and an image display device.

### BACKGROUND ART

Hitherto, investigations have been performed related to optical elements provided with a cell including two or more liquids which are mutually immiscible (for example, an oil and a hydrophilic liquid), and being operated (driven) by application of a voltage. Examples of such optical elements include optical shutters, variable focus lenses, optical pickup lenses, image display devices (3D image display devices included), signage, optical modulators, and pump systems.

Of such optical elements, in recent years there has been particular interest in optical elements utilizing electrowetting phenomena.

Known examples of optical elements utilizing electrowetting phenomena include an electrowetting display (image display device) that is configured with pixel units having a common signal line, a storage capacitor, and a thin-film transistor provided at specific locations, and that includes: a first substrate and a second substrate disposed facing each other; plural projections, disposed with a lattice structure at the opposing face side of the second substrate, defining the plural pixel units; an electrically non-conductive first fluid sealed in the pixel units between two adjacent projections; and a second fluid, sealed between the first fluid and the first substrate, that is a polar or electroconductive liquid immiscible with the first fluid (for example, see Japanese Patent Application Laid-Open (JP-A) No. 2009-86668).

Also known is a display element that switches a display by modifying the amount of light passing through a mask, that is provided with a first and second support member, a first liquid and an electroconductive or polar second liquid, unmixed therewith, sealed in a space formed between the first and second support members, that changes an interfacial profile between the first liquid and the second liquid, and that changes the amount of light passing through a mask by application of a voltage to the second liquid (for example, see JP-A No. 2000-356750).

Also known is a display device that includes a first substrate configuring the display device bottom layer, a first electrode provided above the first substrate, an insulating layer provided above the first electrode, a second electrode provided above the insulating layer, a cavity partition surrounding the second electrode with a space therebetween, a second substrate configuring an uppermost layer provided above the cavity partition, and a colorant liquid droplet sealed in the cavity partition, wherein a third electrode is provided to promote the colorant liquid droplet to regain sphericalness (for example, see JP-A No. 2004-252444).

An optical element utilizing electrowetting phenomena is also known that is a variable focus lens including: a chamber loaded with an electroconductive first liquid; a droplet of an insulating second liquid, having a different refractive index to the first liquid and substantially the same density as the first liquid without being miscible with the first liquid, that is placed on a contact region of a first surface of an insulating wall of the chamber; a center alignment means that maintains center alignment of a voltage source configured to apply a voltage across the first liquid and an electrode disposed above a second surface of the insulating wall with an insulating portion of the liquid droplet over an interval in which the voltage is applied, and that controls the shape thereof (for example, see Japanese National-Phase Publication No. 2001-519539).

### SUMMARY OF INVENTION

### Technical Problem

In optical elements provided with cells that include two or more mutually immiscible liquids (for example, an oil and a hydrophilic liquid), a hydrophobic insulating film in contact with oil is provided to a cell inner face, and a voltage is applied across the hydrophilic liquid and the cell inner face on either sides of the hydrophobic insulating film. Charge is thereby produced at the hydrophobic insulating film face, the profile of the interface between the oil and the hydrophilic liquid is changed by this charge, and the optical element is driven. In this event, oil is uniformly present on the hydrophobic insulating film, and this is an important element in the manufacturability of the cell and driving of the optical element.

Hitherto, examples of hydrophobic insulating films of optical elements employing linear fluoropolymers have been described (for example, JP-A Nos. 2009-86668, 2000-356750, and 2004-252444, and Japanese National-Phase Publication No. 2001-519539 above).

However, fluoropolymers generally tend to have excellent oil repellency together with excellent water repellency, and the wet spreadability of oil on such hydrophobic insulating films is insufficient due to this oil repellency. Therefore the drivability of such optical elements is sometimes unstable due to differences in oil film thickness arising due to oil not wet spreading uniformly. Materials with a more excellent wet spreadability with respect to oil are therefore desired.

In addition to the element fluorine, the element silicon is often employed as an element having water repellency. Since the durability of substances including the element silicon is generally inferior to that of substances including the element fluorine, a means to enhance durability is desired.

In consideration of the above circumstances, the invention addresses the provision of an optical element and an image display device that includes a hydrophobic insulating film that has excellent wet spreadability for oil while maintaining water repellency which is at a similar degree to that of fluoropolymers, and that also has excellent durability.

The specific means of achieving the object are as stated below.
<1> An optical element comprising a cell, the cell comprising:

a first substrate, at least a portion of at least one surface of the first substrate being electroconductive;

a second substrate disposed so as to face the electroconductive surface of the first substrate;

an electrically non-conductive oil and an electroconductive hydrophilic liquid that are provided between the electroconductive surface of the first substrate and the second substrate; and

a hydrophobic insulating film that is provided at at least a portion of the electroconductive surface side of the first substrate, that contacts the oil, and that includes a crosslinked structure derived from a siloxane compound having an unsaturated double bond,

the profile of an interface between the oil and the hydrophilic liquid changing according to a voltage applied across the hydrophilic liquid and the electroconductive surface of the first substrate.
<2> The optical element of <1>, wherein a contact surface area between the oil and the hydrophobic insulating film changes according to the voltage.
<3> The optical element of <1> or <2>, wherein the hydrophobic insulating film is formed by curing a curable composition including the siloxane compound and comprises a crosslinked structure that is produced by polymerization of the siloxane compound.
<4> The optical element of any one of <1> to <3>, wherein the siloxane compound is a compound represented by Formula (1).

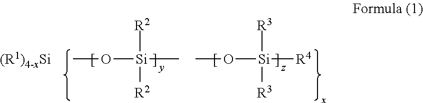

In Formula (1), each of R¹ to R⁴ independently represents an organic group having from 1 to 20 carbon atoms; at least one selected from the group consisting of R¹, R³, and R⁴ includes an unsaturated double bond, and in cases in which a plurality of any one of R¹ to R⁴ are present, the plurality of any one of R¹ to R⁴ may be the same as or different from one another; x represents an integer that satisfies 1≦x≦4; y represents an integer that satisfies 10≦y≦500; z represents an integer that satisfies 0≦z≦500; and the portion consisting of y units of —OSi(R²)2- and z units of —OSi(R³)2- may be a portion formed by random copolymerization or a portion formed by block copolymerization.
<5> An image display device comprising a pixel including the optical element of any one of <1> to <4>, the oil including a coloring material.

### EFFECTS OF INVENTION

The invention enables provision of an optical element and an image display device provided with a hydrophobic insulating film that having excellent wet spreadability for oil while maintaining water repellency which is at a similar degree to that of fluoropolymers and also having excellent durability.

### BRIEF DESCRIPTION OF DRAWINGS

FIG. 1 is a schematic cross-section diagram conceptually illustrating a first embodiment of the invention (voltage-off state).

FIG. 2 is a schematic cross-section diagram conceptually illustrating the first embodiment of the invention (voltage-on state).

FIG. 3 is a schematic cross-section diagram schematically conceptually illustrating a second embodiment of the invention (voltage-off state and voltage-on state).

FIG. 4 is a schematic cross-section diagram conceptually illustrating a test cell employed in an example.

### DESCRIPTION OF EMBODIMENTS

Detailed explanation is given below regarding an optical element, and an image display device of the invention.

Optical Element

The optical element of the invention includes a cell, the cell including: a first substrate, at least a portion of at least one surface of the first substrate being electroconductive; a second substrate disposed so as to face the electroconductive surface of the first substrate; an electrically non-conductive oil and an electroconductive hydrophilic liquid that are provided between the electroconductive surface of the first substrate and the second substrate; and a hydrophobic insulating film that is provided at at least a portion of the electroconductive surface side of the first substrate, that contacts the oil, and that includes a crosslinking structure derived from a siloxane compound having an unsaturated double bond, the profile of an interface between the oil and the hydrophilic liquid changing according to a voltage applied across the hydrophilic liquid and the electroconductive surface of the first substrate.

In the optical element of the invention, a voltage is applied across the electroconductive hydrophilic liquid and the electroconductive surface of the first substrate (namely, through the hydrophobic insulating film). Charge is generated at the surface of the hydrophobic insulating film when the applied voltage has exceeded a specific threshold. As a consequence of this charge, the electroconductive hydrophilic liquid approaches the hydrophobic insulating film (more preferably, the electroconductive hydrophilic liquid displaces the oil that was in contact with the hydrophobic insulating film, and contacts the hydrophobic insulating film), whereby the profile of the interface between the oil and the hydrophilic liquid is changed, and the optical element is operated (driven).

Optical elements driven similarly to the description above are found in conventional optical elements.

However, fluoropolymers employed in water repellent insulating films in conventional optical elements tend to have excellent oil repellency together with excellent water repellency, and the wet spreadability of oil on such hydrophobic insulating films is therefore insufficient. It is therefore found that the drivability of such optical elements is sometimes unstable due to differences in oil film thickness arising due to oil not wet spreading uniformly.

Moreover, although, in addition to the element fluorine, the element silicon is often employed as a substance having water repellency, it is found that the film durability of substances employing the element silicon generally tends to be inferior to substances employing the element fluorine.

In relation to this point, in the optical element of the invention, since the hydrophobic insulating film is configured including a crosslinked structure deriving from a siloxane compound having an unsaturated double bond, the hydrophobic insulating film has excellent lipophilicity whilst maintaining water repellency which is at a similar degree to that of a fluoropolymers. Durability, a concern when the element silicon is employed, can also be ensured by photocuring since the unsaturated double bond is included.

According to the invention, wet spreadability of the oil is accordingly excellent, while water repellency is at a similar degree to that of conventionally used hydrophobic insulating films including fluoropolymers, and enabling an optical element provided with a hydrophobic insulating film having excellent durability to be provided.

In the invention, the voltage (driving voltage) applied across the hydrophilic liquid and the electroconductive surface of the first substrate in order to change the interfacial profile (and, preferably, the contact surface area between the oil and the hydrophobic insulating film) is not particularly limited, and may be freely set within a range of, for example, from 1V to 25V (preferably from 1V to 20V).

Moreover, the driving voltage may be a DC voltage, or may be an AC voltage.

As long as the optical element of the invention is provided with the configuration described above, the applications thereof are not particularly limited.

Examples of preferable applications of the optical element of the invention include an optical shutter described in JP-A No. 2000-356792 and the like, variable focus lenses described in JP-A No. 2001-013306, Japanese National-Phase Publication No. 2001-519539, JP-A No. 2008-96953, and the like, an optical pickup lens described in Japanese National-Phase Publication No. 2007-530997, display or signage described in JP-A Nos. 2009-86668, and H010-39800, Japanese National-Phase Publication Nos. 2005-517993, 2007-531917, JP-A Nos. 2004-252444, and 2004-287008, and the like, a 3D display described in Japanese National-Phase Publication No. 2005-506778 and the like, an optical modulator described in JP-A No. 2010-79297 and the like, a pump system described in United States Patent (USP) No. 2011/0083964 and the like.

The optical element of the invention is preferably an electrowetting element that operates by an electrowetting phenomenon. Electrowetting phenomena are known, and details thereof are as described in the publications cited above.

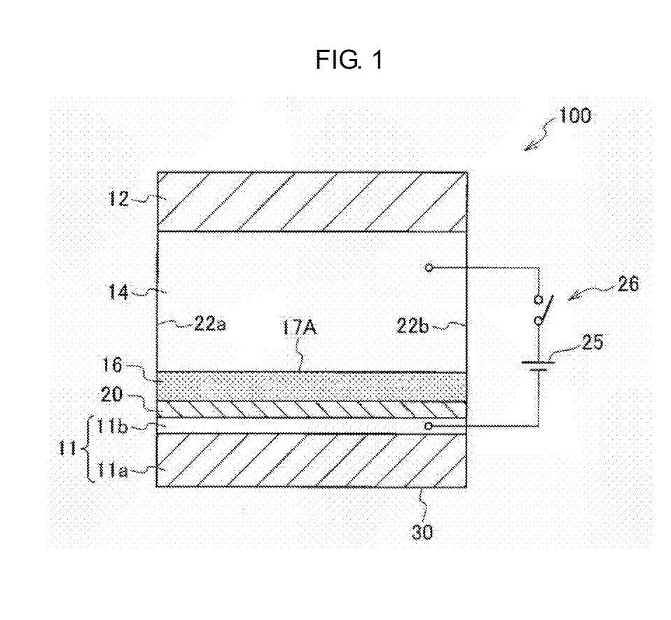

Explanation is given below regarding an embodiment of the optical element of the invention with reference to FIG. 1 to FIG. 3; however, the embodiments of the invention are not limited to those described below.

### First Embodiment

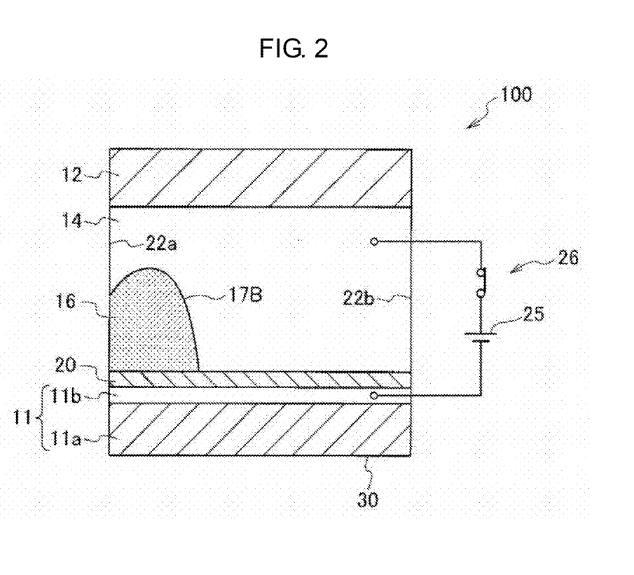

FIG. 1 and FIG. 2 are schematic cross-section diagrams conceptually illustrating a first embodiment of an optical element of the invention. The first embodiment is a preferred embodiment when the optical element of the invention is employed as a pixel of an image display device.

FIG. 1 illustrates a voltage-off state of an optical element 100 (a voltage non-applied state; the same applies below). FIG. 2 illustrates a voltage-on state of the optical element 100 (a voltage applied state; the same applies below).

As illustrated in FIG. 1 and FIG. 2, the optical element 100 is configured including a cell 30, provided with a hydrophilic liquid 14 and an oil 16 in a region compartmented by a side face 22a and a side face 22b, between a hydrophobic insulating film 20 provided to a substrate 11 (a first substrate) and a substrate 12 (a second substrate).

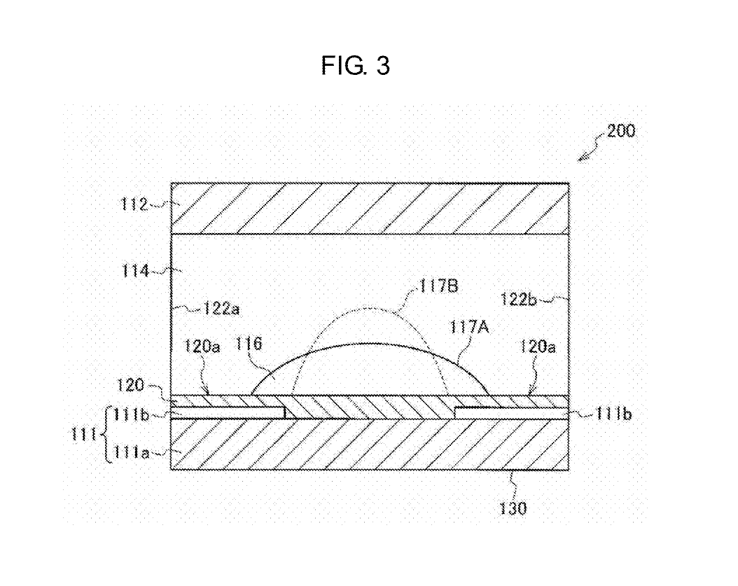

The side face 22a and the side face 22b are configured as, for example, respective side faces of a partitioning wall. Although a space sealed by the hydrophobic insulating film 20, the substrate 12 (the second substrate), the side face 22a, and the side face 22b is formed in FIG. 1 and FIG. 2, the invention is not limited to this configuration. For example, a portion of the side face 22a and the side face 22b (preferably a side portion of the substrate 12 (second substrate)) may be opened (similar applies to a side face 122a and a side face 122b in FIG. 3, described below).

The substrate 11 (the first substrate) is formed of a substrate 11a and an electroconductive film 11b provided to the substrate 11a. The electroconductive film 11b functions as one electrode that applies a voltage across the electroconductive film 11b and the hydrophilic liquid 14.

In the optical element 100, the hydrophobic insulating film 20 is provided so as to be in contact with the electroconductive film 1 lb. The hydrophobic insulating film 20 includes a hydrophobic insulating film crosslinked structure that includes a crosslinked structure deriving from a siloxane compound having an unsaturated double bond.

The hydrophilic liquid 14 and the oil 16 are mutually immiscible liquids, and an interface 17A, or an interface 17B, is a boundary of mutual separation therebetween.

In FIG. 1 and FIG. 2, the interface 17A becomes the interface between the hydrophilic liquid 14 and the oil 16 in the voltage-off state (FIG. 1), and the interface 17B becomes the interface between the hydrophilic liquid 14 and the oil 16 in the voltage-on state (FIG. 2).

The optical element 100 is further provided with a power source 25 (a voltage application unit) that applies a voltage between the electroconductive film 11b and the hydrophilic liquid 14, and a switch 26 for switching between the voltage on/off states.

In the present embodiment, application of the voltage (potential) to the hydrophilic liquid 14 is performed by an electrode inserted into the hydrophilic liquid 14. However, the invention is not limited to this configuration, and configuration may be made such that a surface at the side of the substrate 12 (second substrate) in contact with the hydrophilic liquid 14 is electroconductive (for example, a configuration in which an electroconductive film is present at the side of the substrate 12 (the second substrate) in contact with the hydrophilic liquid 14), and application of voltage (potential) to the hydrophilic liquid 14 may be performed by applying a voltage (potential) to this electroconductive surface (for example, to the electroconductive film).

Next, explanation will be given regarding the operation of the optical element 100 (in the voltage-off state, and the voltage-on state).

As illustrated in FIG. 1, since the affinity of the hydrophobic insulating film 20 to the oil 16 is high in the voltage-off state, a state in which the whole surface of the hydrophobic insulating film 20 is in contact with the oil 16 is adopted.

When voltage is applied to the optical element 100, the interface between the hydrophilic liquid 14 and the oil 16 is reshaped from that of interface 17A (FIG. 1) into that of interface 17B (FIG. 2), the contact surface area between the hydrophobic insulating film 20 and the oil 16 is reduced, and the oil 16 travels to an end of the cell. As described above, this phenomenon is a phenomenon generated such that charge is produced at the surface of the hydrophobic insulating film 20 due to the voltage application, and as a consequence of this charge, the hydrophilic liquid 14 displaces the oil 16 in contact with the hydrophobic insulating film 20, and contacts the hydrophobic insulating film 20.

The optical element 100 returns to the state of FIG. 1 when the voltage in FIG. 2 is set to the off state.

Although the operations illustrated in FIG. 1 and FIG. 2 are performed repeatedly in the optical element 100, strengthened adhesion to the partitioning wall of substrate, due to the hydrophobic insulating film 20 including a crosslinked structure deriving from a siloxane compound having an unsaturated double bond, suppresses deterioration of the hydrophobic insulating film 20 of excellent durability.

Although explanation regarding the first embodiment of the optical element of the invention has been given with reference to FIG. 1 and FIG. 2, the invention is not limited to this embodiment.

For example, although in FIG. 1 and FIG. 2 the electroconductive film 11b is provided spanning the whole substrate 11 (first substrate) surface, configuration may be made such that an electroconductive film is provided to only a portion of a substrate (first substrate) surface.

Moreover, in addition to the electroconductive film 11b being present at the substrate 11 (first substrate) as described above, an electroconductive film may be present at the side of the substrate 12 (second substrate) in contact with the hydrophilic liquid 14.

In the above embodiment, including at least one coloring material in the oil 16, and thereby coloring the oil 16 a desired color (examples include black, red, green, blue, cyan, magenta, and yellow), enables the optical element 100 to be employed as a single pixel in an electrowetting image display device (also referred to simply as “image display device” below). In such cases the oil 16 functions, for example, as an optical shutter that switches a pixel between an on state and an off state. The details of this function are, for example, as described in each of the publications cited above. In such cases, the image display device may be an image display device of any style out of a transmissive type, a reflective type, and a transflective type.

In cases in which the optical element 100 serves as a single pixel of an image display device, partitioning the substrate surface with a partitioning wall, for example, compartmentation into a lattice structure, enables a single compartmented region to serve as a single pixel. By doing so, the electroconductive film 11b may be a film patterned independently for each single pixel (such as in the case of an active matrix-type image display device for example), or may be a film patterned into stripes traversing plural pixels (such as in the case of a passive matrix-type image display device for example).

In cases in which the optical element 100 serves as a single pixel of an image display device, a portion of the side face 22a and the side face 22b of the substrate 12 (second substrate) side may be opened, or a through-space between the hydrophobic insulating film 20 and the substrate 12 (the second substrate) that traverses through plural pixels maybe formed.

In cases in which the optical element 100 serves as a single pixel of an image display device, employing a light transmissive substrate, such as glass or plastic (such as polyethylene terephthalate, or polyethylene naphthalate), as the substrate 11 a and the substrate 12 (the second substrate), and employing a light transmissive film as the electroconductive film 11b and the hydrophobic insulating film 20, enables the optical element 100 to serve as a pixel of a transmissive-type image display device. In a pixel of such a light transmissive-type image display device, provision of a reflective substrate to the cell exterior enables the optical element 100 to serve as a pixel of a reflective-type image display device.

Moreover, employing a film (for example, a metal film such as an Al film, or an Al alloy film) also provided with the function of a reflective substrate as the electroconductive film 11b, or employing a substrate (for example, a metal substrate such as an A1 substrate, or an A1 alloy substrate) also provided with the function of a reflective substrate as the substrate 11a, enables the optical element 100 to serve as a pixel of a reflective-type image display device.

In cases in which an electroconductive portion is provided to both faces of the first substrate, two second substrates may be provided so as to face the respective faces.

In cases in which the optical element 100 of the present embodiment is employed as single pixels of an image display device, the configuration of the cell, the image display device, and other components may be the known configurations described in, for example, JP-A Nos. 2009-86668, and H10-39800, Japanese National-Phase Publication No. 2005-517993, JP-A Nos. 2004-252444, and 2004-287008, Japanese National-Phase Publication Nos. 2005-506778, and 2007-531917, JP-A No. 2009-86668, and the like. Moreover, reference may also be made to the configurations of known active matrix-type or passive matrix-type liquid crystal display devices.

### Second Embodiment

FIG. 3 is a schematic cross-section diagram conceptually illustrating a second embodiment of the optical element of the invention.

The second embodiment is a preferred embodiment when the optical element of the invention is employed as variable focus lens.

As illustrated in FIG. 3, similarly to the optical element 100, an optical element 200 is configured so as to include a cell 130 that is provided with a hydrophilic liquid 114 and an oil 116, and is between a hydrophobic insulating film 120 provided to a substrate 111 (a first substrate), and a second substrate 112 (a second substrate), in a region compartmented by a side face 122a and a side face 122b. Although omitted from illustration in FIG. 3, similarly to the optical element 100, the optical element 200 is connected to a power source and a switch.

The configuration of the optical element 200 is similar to the configuration of the optical element 100, except for the following points.

Namely, an outer circumferential portion 120a of the surface of the hydrophobic insulating film 120, excluding a central portion (preferably a circular region), is treated so as to be hydrophilic. Since the oil 116 thereby contacts only the central portion (preferably a circular region) of the surface of the hydrophobic insulating film 120, an interface 117A between the oil 116 and the hydrophilic liquid 114 forms a curved surface in the voltage-off state.

Moreover, the substrate 111 (the first substrate) is configured by a substrate 111a, and an electroconductive film 111b, patterned such that the central portion (preferably a circular region) of the surface of the substrate 111a is exposed. The electroconductive film 111b is thus patterned such that, in the voltage-off state, a pattern edge is positioned in a contact region between the oil 116 and the hydrophobic insulating film 120, as viewed along a direction orthogonal to the surface of the substrate 111a.

In the optical element 200, the substrate 111 (the first substrate), the hydrophobic insulating film 120, the oil 116, the hydrophilic liquid 114, and the second substrate 112 (the second substrate) are light transmissive.

The oil 116 thereby functions as a lens.

In FIG. 3, the interface between the oil 116 and the hydrophilic liquid 114 is the interface 117A in the voltage-off state, and the interface between the oil 116 and the hydrophilic liquid 114 is an interface 117B in the voltage-on state.

As illustrated in FIG. 3, although the interface between the oil 116 and the hydrophilic liquid 114 in the voltage-on state already has a specific curvature (interface 117A), the curvature of the interface further increases (interface 117B) when the voltage-off state is adopted. The reason is that, similarly to in the first embodiment, charge is produced at the surface of the hydrophobic insulating film 120 (the contact face with the oil 116) when the voltage is applied.

In this manner, the curvature of the interface between the oil 116 and the hydrophilic liquid 114 can be changed, and the focal length of the oil 116, acting as a lens, can be changed, by the voltage application.

Also in the optical element 200, production and elimination of charge at the hydrophobic insulating film 120 surface is repeated by repeatedly adopting the voltage-on and voltage-off states.

Here also, since the hydrophobic insulating film 120 includes a crosslinked structure deriving from a siloxane compound having an unsaturated double bond, deterioration of the hydrophobic insulating film 120 during repeated driving is suppressed.

The optical element 200 is merely a single example of a case in which the oil 116 is employed as a variable focus lens, and various modifications to the configuration thereof are possible. For example, changing to a configuration in which the outer circumferential portion 120a is not subjected to hydrophilizing treatment, such that the oil 116 is allowed to contact the whole surface of the hydrophobic insulating film 120, and an electroconductive film and a hydrophobic insulating film are provided to both the side face 122a and the side face 122b, enables a change in only the profile (lens focal length) of the interface between the hydrophilic liquid 114 and the oil 116, without changing the contact surface area between the hydrophobic insulating film 120 and the oil 116.

Examples of specific configurations that may be referred to for optical elements employed as variable focus lenses include the descriptions of known configurations of Japanese Patent No. 4154858, JP-A No. 2001-013306, Japanese National-Phase Publication No. 2001-519539, and JP-A No. 2008-96953.

Next, explanation is given regarding individual members and materials employed in the optical element of the invention.

Hydrophobic Insulating Film

The hydrophobic insulating film of the invention is a film provided to at least one portion of the electroconductive surface side of the first substrate, and is a film that contacts the oil.

“Hydrophobic” in the invention is not particularly limited, and, for example, denotes a property of having a water contact angle of 60° or greater (preferably 70° or greater, and more preferably 80° or greater).

Specifically, the method described in “6. Sessile-drop method” of JIS R3257 “Testing method of wettability of glass substrate” is applicable to the water contact angle.

More specifically, a contact angle measuring device (contact angle meter CA-A manufactured by Kyowa Interface Science Co., Ltd.) is employed, a water droplet with a size of 20 mm² is made and released from a needle point to form a water droplet which contacts the hydrophobic insulating film, the shape of the water droplet is inspected through an aperture of the contact angle measuring device after allowing to stand for 10 seconds, and the contact angle θ of the droplet at 25° C. is determined.

“Insulating” in the invention is not particularly limited, and, for example, denotes a property of having a resistivity of 10⁷ Ωcm or greater (preferably 10⁸ Ωcm or greater, and more preferably 10⁹ Ωcm or greater).

The hydrophobic insulating film includes a crosslinked structure deriving from a siloxane compound having an unsaturated double bond. Thereby, the hydrophobic insulating film can be produced exclusively at the required locations since patterning becomes possible and designs in which a partitioning wall is in close contact with a substrate are possible. Accordingly, the EWD cell durability is excellent, in contrast to cases of a hydrophobic insulating film that does not include a crosslinked structure (for example, a case in which only a linear polymer is employed as the polymer included in the hydrophobic insulating film).

The crosslinked structure is preferably formed by polymerization of at least one polyfunctional compound having an unsaturated double bond (together with other monomers if necessary).

Siloxane Compound Having an Unsaturated Double Bond

The hydrophobic insulating film of the invention includes a crosslinked structure deriving from a siloxane compound having an unsaturated double bond.

The hydrophobic insulating film that includes a crosslinked structure may, for example, be formed by curing a curable composition including a siloxane compound having an unsaturated double bond (preferably a polysiloxane compound having an unsaturated double bond). The siloxane compound having an unsaturated double bond enables to freely control the introduced amount of siloxane components by appropriate adjustment of an addition amount thereof.

The siloxane compound having an unsaturated double bond is preferably the compound represented by Formula (1) below (also referred to as “polysiloxane compound represented by Formula (1)” hereafter).

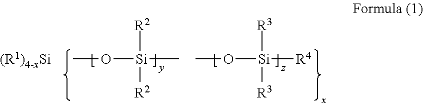

In Formula (1), each of R¹ to R⁴ independently represents an organic group having from 1 to 20 carbon atoms. At least one selected from the group consisting of R¹, R³, and R⁴ is a group including an unsaturated double bond. In cases in which a plurality of any one of R¹ to R⁴ are present, the plurality of any one of R¹ to R⁴ may be the same as or different from one another. x represents an integer that satisfies 1≦x≦4. y represents an integer that satisfies 10≦y≦500. z represents an integer that satisfies 0≦z≦500. In Formula (1), the portion consisting of y units of —OSi(R²)2- and z units of —OSi(R³)2- may be a portion formed by random copolymerization or a portion formed by block copolymerization.

Examples of groups having the unsaturated double bond include groups having a (meth)acryloyl group and groups having an allyl group.

Herein, (meth)acryloyl denotes either an acryloyl group or a methacryloyl group.

The group having a unsaturated double bond is more preferably a (meth)acryloyloxyalkyl group, or a (meth)acryloylaminoalkyl group.

In Formula (1), R² is a substituted or unsubstituted organic group having from 1 to 20 carbon atoms (preferably from 1 to 10 carbon atoms), is preferably an alkyl group having from 1 to 10 carbon atoms (examples thereof include a methyl group, an ethyl group, and a hexyl group), a fluorinated alkyl group having from 1 to 10 carbon atoms (such as a trifluoromethyl group, or a pentafluoroethyl group), or an aryl group having from 6 to 20 carbon atoms (examples thereof include a phenyl group, and a naphthyl group), is more preferably an alkyl group having from 1 to 5 carbon atoms, a fluorinated alkyl group having from 1 to 5 carbon atoms, or a phenyl group, and is particularly preferably a methyl group.

In Formula (1), each of R¹ to R⁴ independently represents an substituted or unsubstituted organic group having from 1 to 20 carbon atoms (preferably from 1 to 10 carbon atoms) that may include an unsaturated double bond, are preferably an alkyl group having from 1 to 10 carbon atoms (examples thereof include a methyl group, an ethyl group, and a hexyl group), a fluorinated alkyl group having from 1 to 10 carbon atoms (such as a trifluoromethyl group, or a pentafluoroethyl group), an aryl group having from 6 to 20 carbon atoms (examples thereof include a phenyl group, and a naphthyl group), a (meth)acryloyloxyalkyl group having from 1 to 10 carbon atoms, or a (meth)acryloylaminoalkyl group having from 1 to 10 carbon atoms, are more preferably an alkyl group having from 1 to 5 carbon atoms, a fluorinated alkyl group having from 1 to 5 carbon atoms, a phenyl group, a (meth)acryloyloxyalkyl group having from 1 to 10 carbon atoms, or a (meth)acryloylaminoalkyl group having from 1 to 10 carbon atoms, and particularly preferably represents a methyl group, a (meth)acryloyloxyalkyl group having from 1 to 10 carbon atoms, or a (meth)acryloylaminoalkyl group having from 1 to 10 carbon atoms.

However, at least one selected from the group consisting of R¹, R³, and R⁴ contains a group having an unsaturated double bond (preferably a (meth)acryloyloxyalkyl group or a (meth)acryloylaminoalkyl group).

x represents an integer that satisfies 1≦x≦4.

y represents an integer that satisfies 10≦y≦500, is preferably an integer that satisfies 50≦y≦400, and is particularly preferably an integer that satisfies 100≦y≦300.

z represents an integer that satisfies 0≦z≦500, is preferably an integer that satisfies 0≦z≦y, and is particularly preferably an integer that satisfies 0≦z≦0.5y.

In Formula (1), a portion consisting of y siloxane units (namely, —OSi(R²)2-) and z siloxane units (namely, —OSi(R³)2-) may be a portion formed by random copolymerization of monomers that form these units, or may be a portion formed by block copolymerization of monomers that form these units. Moreover, this portion may be formed by homopolymerization of monomers that form y siloxane units (namely, —OSi(R²)2-) (z is 0 in this case).

The weight-average molecular weight (Mw) of the compounds represented by Formula (1) is preferably from 10³ to 10⁶, is more preferably from 5×10³ to 5×10⁵, and is particularly preferably from 10⁴ to 10⁵.

A commercially available product may be employed as the compound represented by Formula (1), with examples thereof including: “KF-100T”, “X-22-169AS”, “KF-102”, “X-22-3701IE”, “X-22-164B”, “X-22-5002”, “X-22-173B”, “X-22-174D”, “X-22-167B”, and “X-22-161AS” ((trade names), the above manufactured by Shin-Etsu Chemical Co., Ltd.); “AK-5”, “AK-30”, and “AK-32” ((trade names), the above manufactured by Toagosei Co., Ltd.); “SILAPLANE FMO275”, and “SILAPLANE FM0721” ((trade names), the above manufactured by JNC Coporation); and “TEGORad2010”, “TEGORad2011”, “TEGORad2100”, “TEGORad2200N”, “TEGORad2250”, “TEGORad2300”, “TEGORad2500”, “TEGORad2600”, and “TEGORad2700” ((trade names), the above manufactured by Evonik Degussa Japan), and may also be synthesized by a method such as introduction of an unsaturated double bond into a commercially available polysiloxane compound having a reactive group such as a hydroxide group, an amino group, or a mercapto group.

Preferable examples of the polysiloxane compounds represented by Formula (1) are illustrated below; however, the invention is not limited thereto.

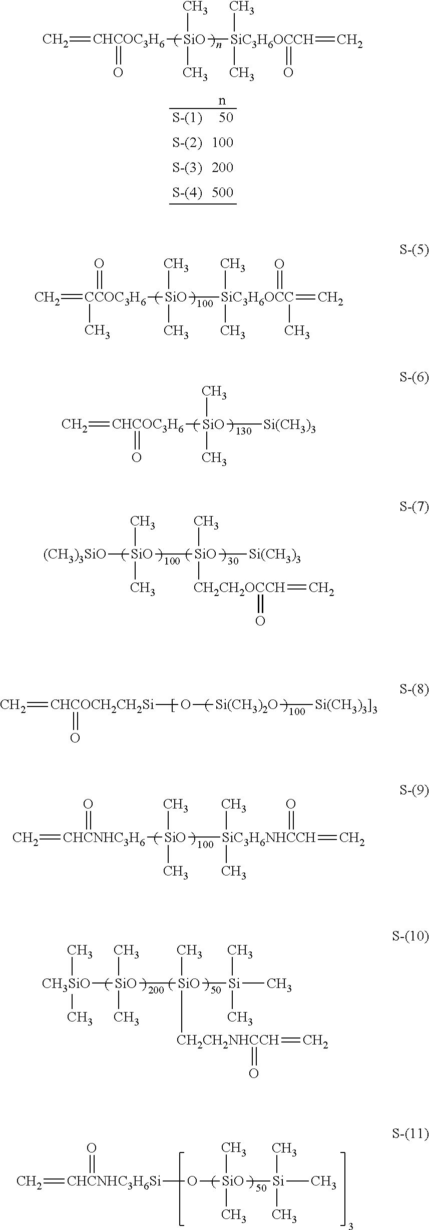

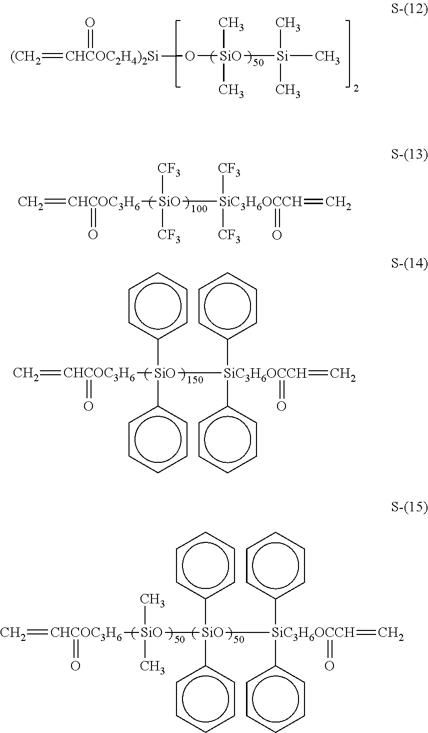

Polymer Deriving from a Siloxane Compound Having an Unsaturated Double Bond

The siloxane compound having an unsaturated double bond (preferably a polysiloxane compound; the same applies below) may be polymerized by various polymerization methods, and may be incorporated into the hydrophobic insulating film as a polymer deriving from the siloxane compound. In the polymerization, the siloxane compound may be homopolymerized, or copolymerized, and the siloxane compound may be employed as a crosslinking agent.

In cases in which the compound represented by Formula (1) is employed as the siloxane compound, the polymer included in the hydrophobic insulating film may be a homopolymer of the compound represented by Formula (1), or may be a copolymer of the compound represented by Formula (1) with another monomer.

A conventionally used monomer may be used as the other monomer in the copolymer, and particularly typical examples of such monomers include radical polymerizable monomers such as methyl(meth)acrylate, ethyl(meth)acrylate, propyl(meth)acrylate, 2,2,2-trifluoroethyl(meth)acrylate, 2,3-pentafluoropropyl(meth)acrylate, 1H,1H,5H-octafluoropentyl(meth)acrylate, 1H,1H,7H-dodecafluoroheptyl(meth)acrylate, 1H,1H,9H-hexadecafluorononyl(meth)acrylate, 2-(perfluorobutyl)ethyl(meth)acrylate, 2-(perfluorohexyl)ethyl(meth)acrylate, 2-(perfluorooctyl)ethyl(meth)acrylate, pentaerythritoltetra(meth)acrylate, dipentaerythritolhexa(meth)acrylate, stearyl(meth)acrylate, ethylene glycoldi(meth)acrylate, allylalcohol, ethylallylether, a-fluoroacrylic acid methylester, vinyl acetate, ethylvinylketone, and butylvinylketone.

Herein, (meth)acrylate denotes either acrylate or methacrylate.

Bulk polymerization and solution polymerization are preferable examples of methods of polymerizing the siloxane compound.

Examples of polymerization initiation methods include a method employing a polymerization initiator (for example, a radical initiator), a method of irradiation with light or radiation, a method of adding acid, and a method of irradiating with light after adding a photoacid generator. These polymerization methods, and polymerization initiation methods, are described in, for example, Tsuruta Teiji, “Polymer Synthesis Methods” Amended Edition (Nikkan Kogyo Shimbun, 1971), and Otsu Takayuki and Kinoshita Masayoshi, “Experimental Techniques in Polymer Synthesis”, Kagaku Dojin, 1972, pages 124 to 154.

Curable Composition

The hydrophobic insulating film of the invention may be appropriately produced by employing a curable composition including the siloxane compound.

The curable composition may include a single siloxane compound, or two or more thereof.

The curable composition may further include a monofunctional compound.

The monofunctional compound is not particularly limited and may be a known monofunctional monomer. For example, monofunctional monomers, appropriately selected from the monomers given above as examples of the copolymerized other monomer, may be employed as the monofunctional compound.

Although not particularly limited, from the viewpoint of curability, the content of the polyfunctional compound (the total content in cases in which there are two or more thereof; the same applies below) in the curable composition is preferably 30% by mass or greater, more preferably 40% by mass or greater, and particularly preferably 50% by mass or greater, with respect to the total solid content of the curable composition. Herein, total solid content denotes the total content excluding a solvent.

Moreover, in cases in which the curable composition includes a polysiloxane compound represented by Formula (1) serving as at least one type of the polysiloxane compound, the content of the polysiloxane compound represented by Formula (1) is preferably 30% by mass or greater, more preferably 40% by mass or greater, and particularly preferably 50% by mass or greater, with respect to the total solid content of the curable composition.

The curable composition preferably further includes one or more solvent.

Examples of the solvent include ethyl, butyl acetate, acetone, methylethylketone, methylisobutylketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, 1-butanol, propylene glycol monomethyl ether, propylene glycol monomethyl ether acetate, cyclohexanone, cyclohexanol, ethyl lactate, methyl lactate, and caprolactam.

The content of the solvent (the total content in cases in which there are two or more thereof) in the curable composition is preferably from 20% by mass to 90% by mass, more preferably from 30% by mass to 80% by mass, and particularly preferably from 40% by mass to 80% by mass, with respect to the total mass of the curable composition.

The curable composition preferably further includes at least one polymerization initiator.

The polymerization initiator is preferably a polymerization initiator that generates radicals by the action of at least one selected from the group consisting of heat and light.

An organic or inorganic peroxide, an organic azo compound, a diazo compound, or the like may be employed as the polymerization initiator that initiates radical polymerization by the action of heat.

Examples of the organic peroxide include benzoyl peroxide, halogenated benzoyl peroxides, lauroyl peroxide, acetyl peroxide, dibutyl peroxide, cumene hydroperoxide, and butyl hydroperoxide. Examples of the inorganic peroxide include hydrogen peroxide, ammonium persulfate, and potassium persulfate. Examples of the organic azo compound include 2-azo-bis-isobutyronitrile, 2-azo-bis-propionitrile, and 2-azo-bis-cyclohexane dinitrile. Examples of the diazo compound include diazoaminobenzene and p-nitrobenzene diazonium.

Examples of the polymerization initiator that initiates radical polymerization by the action of light include hydroxyalkylphenones, aminoalkylphenones, acetophenones, benzoins, benzophenones, phosphineoxides, ketals, anthraquinones, thioxanthones, azo compounds, peroxide compounds, 2,3-dialkyldione compounds, disulfide compounds, fluoroamine compounds, and aromatic sulfoniums.

Examples of the hydroxyalkylphenones include 2-hydroxy-2-methyl-1-phenyl-1-propane-1-one, 1-hydroxy-cyclohexyl-phenyl-ketone, 1-[4-(2-hydroxyethoxy)-phenyl]-2-hydroxy-2-methyl-1-propane-1-one, 2-hydroxy-1-{4-[4-(2-hydroxy-2-methyl-propionyl)-benzyl]phenyl}-2-methyl-propane-1-one, 1-hydroxydimethylphenyl ketone, and 1-hydroxycyclohexylphenyl ketone.

Examples of the aminoalkyl phenone include 2-dimethyl amino-2-(4-methylbenzyl)-1-(4-morpholine-4-ylphenyl)butan-1-one, 2-benzyl-2-dimethylamino-1-(4-morpholinophenyl)-1-butanone, and 2-methyl-1-(4-methylthiophenyl)-2-morpholinopropan-1-one.

Examples of the acetophenones include 2,2-diethoxyacetophenone and p-dimethylacetophenone. Examples of the benzoins include benzoin benzenesulfonate, benzoin toluenesulfonate, benzoin methylether, benzoin ethyl ether, and benzoin isopropyl ether. Examples of the benzophenones include benzophenone, 2,4-dichlorobenzophenone, 4,4-dichlorobenzophenone, and p-chlorobenzophenone. Examples of the phosphine oxides include 2,4,6-trimethyl benzoyl diphenyl phosphine oxide.

A sensitizing dye may also be employed in combination with these polymerization initiators.

Although not particularly limited, the content of the polymerization initiator is preferably from 0.1% by mass to 15% by mass, more preferably from 0.5% by mass to 10% by mass, and particularly preferably from 2% by mass to 5% by mass, with respect to the total solid content of the curable composition.

The curable composition may include other components if necessary.

Examples of such other components include inorganic oxide particulates, silicone-containing or fluorine-containing antifoulants, lubricants, polymerization inhibitors, silane coupling agents, surfactants, thickeners, and levelling agents.

The content of such other components is preferably within a range of from 0% by mass to 30% by mass, more preferably within a range of from 0% by mass to 20% by mass, and particularly preferably within a range of from 0% by mass to 10% by mass, with respect to the total solid content of the curable resin composition.

Although not particularly limited, the film thickness of the hydrophobic insulating film of the invention is preferably from 50 nm to 10 μm, and more preferably from 100 nm to 1 μm. When the film thickness of the hydrophobic insulating film is within the above ranges, this is preferable from the viewpoint of balancing insulation performance against the driving voltage.

Method of Producing the Hydrophobic Insulating Film

The hydrophobic insulating film of the invention may be preferably produced by a method including: a curable layer formation process that forms a curable layer on the electroconductive surface side of the first substrate (for example, at least above the electroconductive film in cases in which the first substrate includes an electroconductive film) using the curable composition including the siloxane compound; and a curing process that cures the curable layer by polymerization of the siloxane compound in the formed curable layer. The hydrophobic insulating film that includes the crosslinked structure is produced thereby.

Formation of the curable layer to above the first substrate may be performed by known coating methods or transfer methods.

In the case of a coating method, the curable composition is applied on the first substrate (and preferably dried) to form a curable layer. Although not particularly limited, examples of known coating methods that may be used include spin coating methods, slit coating methods, dip coating methods, air knife coating methods, curtain coating methods, roller coating methods, wire bar coating methods, gravure coating methods, and extrusion coating methods.

In the case of a transfer method, a transfer material including a curable layer formed using the curable composition is prepared in advance, and the curable layer is formed above the first substrate by transferring the curable layer of the transfer material onto the first substrate. For details regarding the transfer method, for example, paragraphs 0094 to 0121 of JP-A No. 2008-202006, and paragraphs 0076 to 0090 of JP-A No. 2008-139378 may be referenced.

Curing the curable layer (polymerizing the polysiloxane compound having an unsaturated double bond) may be performed using, for example, at least one selected from the group consisting of irradiation with actinic energy rays (also referred to as “exposure” hereafter), and heating.

Although the actinic energy rays used in exposure are not particularly limited, ultraviolet rays (such as a g-ray, h-ray, or i-ray), an electron beam, or x-rays are preferably employed therefor. The exposure may be performed using known exposure apparatus such as a proximity-type, a mirror projection-type, or a stepper-type.

Although the amount of exposure light in the exposure may be set as is appropriate, for example, from 10 mJ/cm² to 2000 mJ/cm² may be used, and from 50 mJ/cm² to 1000 mJ/cm² is preferable.

Moreover, a hydrophobic insulating film with the desired patterning may be obtained by exposing through a specific photomask, and then developing using a developer liquid such as an alkali solution.

The heating may, for example, be performed by a known method employing a hotplate or an oven.

Although the heating temperature may be set as appropriate, a setting of, for example, from 100° C. to 280° C. may be used, and from 150° C. to 250° C. is preferable. Although the heating time may also be set as appropriate, a setting of, for example, from 2 minutes to 120 minutes may be used, and from 5 minutes to 60 minutes is preferable.

First Substrate, Second Substrate

The first substrate of the invention is a substrate that has at least one surface with at least a portion that is electroconductive.

The second substrate of the invention is a substrate that is disposed so as to face the electroconductive surface of the first substrate.

From the viewpoint of employing the optical element of the invention as an image display device or a variable focus lens, preferably at least one out of the first substrate and the second substrate have light transmissivity. Specifically, a transmittance of 80% or greater nm (more preferably 90% or greater) across the whole of the wavelength range of from 380 nm to 770 nm is preferable.

First Substrate

The first substrate is not particularly limited, provided that at least a portion of at least one surface thereof is electroconductive. The electroconductive surface functions as an electrode in the optical element.

Herein, “electroconductive” is not particularly limited, as long as this property is sufficient to enable the voltage to be applied. For example, a surface resistivity of 500 Ω/sq or lower (preferably 70 Ω/sq or lower, more preferably 60 Ω/sq or lower, and still more preferably 50 Ω/sq or lower) is desirable.

The first substrate may be an electroconductive substrate (such as a metal substrate) constituted by a single sheet, or may be a substrate constituted by a supporting substrate and an electroconductive film (this may be a patterned electroconductive film, or may be a non-patterned electroconductive film) provided above the supporting substrate.

Of these, the first substrate is preferably constituted by a supporting substrate and an electroconductive film provided above the supporting substrate, from the viewpoint of employing the optical element of the invention as an image display device or a variable focus lens. In such a configuration, the electroconductive surface of the first substrate corresponds to the surface of the electroconductive film.

Examples that may be employed as the supporting substrate include glass substrates (examples including alkali-free glass substrates, soda glass substrates, PYREX (registered trademark) glass substrates, and quartz glass substrates), plastic substrates (examples including polyethylene naphthalate (PEN) substrates, polyethylene terephthalate (PET) substrates, polycarbonate (PC) substrates, and polyimide (PI) substrates), metal substrates such as aluminum substrates or stainless steel substrates, and semiconductor substrates such as silicon substrates. Of these, a glass substrate or a plastic substrate is preferable from the viewpoint of light transmissivity.

A TFT substrate provided with a thin-film transistor (TFT) may be employed as the supporting substrate. In such cases, a configuration in which the electroconductive film is connected to the TFT (namely, the electroconductive film is a pixel electrode connected to the TFT) is desirable. This thereby enables the voltage to be applied independently for each pixel, and, similarly to in known liquid crystal display devices provided to TFTs, active driving of the entire image display device is enabled.

In the TFT substrate, the TFT, various wires, a storage capacitor, and the like may be disposed as is conventional. For example, the disposition described in JP-A No. 2009-86668 may be referred to.

Although not particularly limited, the resistivity of the electroconductive film may, for example, be 1.0×10⁻³ Ωcm or less.

Although a metal film may be employed as the electroconductive film, a transparent electroconductive film is preferable from the viewpoint of light transmissivity.

The transparent electroconductive film preferably has a transmittance of 80% or greater (more preferably 90% or greater) across the whole of the wavelength range of from 380 nm to 770 nm.

Examples of the transparent electroconductive film include films containing at least one selected from the group consisting of indium tin oxide (also known as ITO), indium zinc oxide (also known as IZO), tin oxide, indium oxide, zirconium oxide, zinc oxide, cadmium oxide, and magnesium oxide.

Of these, a film including indium tin oxide (ITO) is preferable as the transparent electroconductive film from the viewpoints of light transmissivity, and electroconductivity.

In a film containing indium tin oxide (ITO), an addition amount of tin oxide of from 5% by mass to 15% by mass is preferable for reducing the resistivity, and from 8% by mass to 12% by mass is more preferable.

Second Substrate

The second substrate is not particularly limited, and, for example, the substrates given as examples of the supporting substrate above may be used therefor.

Similarly to for the first substrate, a substrate that has at least one surface with at least a portion that is electroconductive may also be employed as the second substrate, and in such a case, the preferable configuration of the second substrate is similar to the preferable configuration of the first substrate.

In a configuration in which the second substrate includes an electroconductive film, this electroconductive film, for example, functions as an electrode for supplying a potential to a hydrophilic liquid.

A particularly preferable configuration in cases in which the optical element of the invention is employed as a pixel of an image display device is a configuration in which the voltage is imparted to each pixel independently by imparting a potential to each of the pixels independently in the electroconductive film surface of the first substrate, while the electroconductive film of the second substrate is imparted with a shared potential that spans plural pixels. Regarding such configurations, configurations of known liquid crystal display devices may be referred to.

Oil

The oil of the invention is an electrically non-conductive oil.

The oil may be a single component oil, or may be an oil that includes two or more components (an oil composition).

Moreover, “electrically non-conductive” is not particularly limited, and, for example, denotes a property of exhibiting a resistivity of 10⁶ Ωcm or greater (preferably 10⁷ Ωcm or greater).

The oil preferably has a low relative permittivity.

Specifically, the relative permittivity of the oil is preferably within a range of 10.0 or less, and more preferably within a range of from 2.0 to 10.0. In contrast to cases in which the relative permittivity exceeds 10.0, this range is preferable from the viewpoint of enabling fast response driving (operation) at a lower voltage.

Herein, relative permittivity is a value, measured at 20° C. and 40% RH using a 2353LCR meter (measurement frequency: 1 kHz) manufactured by NF Corporation, of the electrical capacitance of a cell obtained by injecting the oil into a glass cell fitted with an ITO transparent electrode that has a 10 μm cell gap.

The viscosity of the oil is preferably a dynamic viscosity of 10 mPa·s or lower at 20° C. Of this range, the viscosity is preferably 0.01 mPa·s or greater, and more preferably from 0.01 mPa·s to 8 mPa·s. In contrast to cases of viscosities exceeding 10 mPa·s, the viscosity of the oil being 10 mPa·s or lower is preferable from the viewpoint of enabling fast response driving at a lower voltage.

Note that the dynamic viscosity is a value measured using a viscometer (500 model, manufactured by Toki Sangyo Co., Ltd.) at a temperature adjusted to 20° C.

The oil is preferably substantially immiscible with the hydrophilic liquid described below.

Specifically, the solubility of the oil in the hydrophilic liquid (at 25° C.) is preferably 0.1% by mass or lower, more preferably 0.01% by mass or lower, and particularly preferably 0.001% by mass or lower.

The oil preferably includes at least one non-polar solvent as a solvent. Herein, non-polar solvent refers to a solvent which has a low relative permittivity value and which may be referred to as a solvent having no polarity.

Examples of the non-polar solvent include: aliphatic hydrocarbon-containing solvents such as n-hexane, n-decane, dodecane, tetradecane, or hexadecane (aliphatic hydrocarbon-containing solvents having from 6 to 30 carbon atoms are preferable); solvents obtained by substituting the aliphatic hydrocarbon-containing solvents with fluorine (examples thereof include fluorocarbon oils); and silicone-containing solvents (examples thereof include silicone oils). Of these, aliphatic hydrocarbon-containing solvents are preferable.

The content of the non-polar solvent is preferably 70% by mass or greater, and more preferably 90% by mass or greater with respect to the total solvent content included in the oil. A content of non-polar solvent of 70% by mass or greater enables more excellent optical shutter characteristics to be exhibited. Moreover, in cases in which the oil includes a coloring material, the solubility of the coloring material in the oil is better maintained.

Coloring Material

In cases in which the optical element of the invention is employed as, for example, a pixel of an image display device, the oil preferably includes at least one coloring material.

The coloring material is not particularly limited, and may be freely selected from colorants having solubility or dispersibility in the non-polar solvent, within a range that does not impair the effects of the invention.

The coloring material is preferably a dye or pigment exhibiting solubility in the non-polar solvent, and is more preferably a dye.

The coloring material is not particularly limited, and may, for example, be appropriately selected from colorants that are soluble in non-polar solvents out of known colorants in the field of image display device color filters (examples thereof include liquid crystal display device color filters, and solid-state image element color filters), and employed.

Examples of the colorants include various colorants such as methine colorants (examples thereof include pyrazolone methine colorants, pyridone methine colorants, isooxazolone methine colorants, and isooxazoline methine colorants), azomethine colorants (examples thereof include pyrazolone azomethine colorants, pyridone azomethine colorants, isooxazolone azomethine colorants, pyrrolotriazole azomethine colorants, pyrazolone triazole azomethine colorants, and naphthol azomethine colorants), azo colorants (for example, monoazo colorants, bisazo colorants, benzothiazolylmonoazo colorants, pyrazole azo colorants, anilinoazo colorants, pyrazolotriazole azo colorants, and pyridone azo colorants), dipyrromethene colorants, anthraquinone colorants, triphenylmethane colorants, anthrapyridone colorants, benzylidene colorants, oxonol colorants, cyanine colorants, phenothiazine colorants, xanthene colorants, phthalocyanine colorants, benzopyran colorants, or indigo colorants.

More specific examples of the colorant include Oil Blue N (alkylamine-substituted anthraquinone), Solvent Green, Sudan Red, and Sudan Black.

Moreover, the coloring materials described in International Publication (WO) Nos. 2011/111710 and 2008/142086, and JP-A No. 2009-138189 may also be preferably used as the coloring material.

The colorant may be synthesized in accordance with a known method.

For example, synthesis of the azomethine colorant may be performed in accordance with methods described in Journal of the American Chemical Society (J. Am. Chem. Soc.), 1957, vol. 79, page 583, JP-ANos. H09-100417, 2011-116898, 2011-12231, 2010-260941, and 2007-262165, and the like.

Synthesis of the pyrazolone methine colorant may, for example, be performed in accordance with methods described in JP-A Nos. 2008-248123, H02-3450, and S49-114420, Japanese Patent No. 2707371, JP-A Nos. H05-45789, 2009-263517, and H03-72340, and the like.

Synthesis of the isooxazolone methine colorant may, for example, be performed in accordance with the methods described in Japanese Patent No. 2707371, JP-A Nos. H05-45789, 2009-263517, and H03-72340, and the like.

Synthesis of the monoazo colorant, the bisazo colorant, and the anthraquinone colorant may, for example, be performed in accordance with the methods described in: Yutaka Hosoda, “Recent Dye Chemistry” (21 Dec. 1973, Gihodo Shuppan); A. V. Ivashchenko, Dichroic Dyes for Liquid Crystal Displays, CRC Press, 1994; Bulletin of the Chemical Society of Japan, vol 76, pages 607-612, 2003; Bulletin of the Chemical Society of Japan, vol 72, pages 127-132, 1999; and the like.

Synthesis of the dipyrromethene colorant may, for example, be a synthesis in accordance with the methods described in JP-A No. 2008-292970.

The synthesis of the azo colorant may be produced in accordance with known methods described in Japanese Patent Nos. 4408380, 4642403, 4357383, and 4359541, JP-A Nos. 2006-91190, 2007-31616, and 2007-39478, Japanese Patent No. 4597806, JP-A No. 2002-371079, and Japanese Patent No. 4666873, and the like.

The coloring material may be employed singly, or in a combination of two or more thereof.

In cases in which the oil includes a coloring material, the content of the coloring material is not particularly limited, and preparation may be carried out at a freely selected concentration according to the purpose.

The content of the coloring material may be set at, for example, 0.2% by mass or greater with respect to the total mass of the oil, and may be diluted by a solvent (for example, the non-polar solvent) according to a required εC value (where 8 is the absorption coefficient of the oil).

From the viewpoints of hue and color density, the content of the coloring material is preferably 20% by mass or greater, more preferably 30% by mass or greater, still more preferably 40% by mass or greater, and particularly preferably 50% by mass or greater with respect to the total mass of the oil.

The oil may include various additives such as ultraviolet absorbents, or antioxidants, if necessary. Although not particularly limited, additives are generally employed at a content of approximately 20% by mass or lower with respect to the total mass of the oil.

Hydrophilic Liquid

The hydrophilic liquid of the invention is an electroconductive hydrophilic liquid.

Herein, “electroconductive” is not particularly limited, and, for example, denotes a resistivity of 10⁵ Ωcm or lower (preferably 10⁴ Ωcm or lower).

The hydrophilic liquid may be constituted including, for example, an electrolyte, and a water miscible solvent.

Examples of the electrolyte include salts such as sodium chloride, potassium chloride, or tetrabutylammonium chloride.

The concentration of the electrolyte in the hydrophilic liquid is preferably from 0.1 to 10 mol/L, and more preferably from 0.1 to 5 mol/L.

The hydrophilic liquid may include a water miscible solvent other than water as the water miscible solvent. Examples of the water miscible solvent other than water include alcohol solvents such as ethanol.

Other Components

The optical element of the invention preferably includes a partitioning wall, above the first substrate, that defines regions of the cell. As described above, the partitioning wall may be in contact with the second substrate, or may be in non-contact with second substrate.

The partitioning wall preferably includes a resin, and, for example, may be configured similarly to known partitioning walls employed in image display devices such as liquid crystal display devices.

The partitioning wall may be formed by, for example, a known photolithographic method employing a photosensitive resist, or a photosensitive film.

If necessary, the optical element of the invention may further include a voltage application unit (for example, a power source) that applies a voltage across the hydrophilic liquid and the electroconductive surface of the first substrate, and other components such as a spacer for ensuring a cell gap (separation between the hydrophobic insulating film surface provided to the first substrate, and the second substrate). For example, known components employed in image display devices such as liquid crystal display devices may be employed as the other components employed in the optical element of the invention.

Although not particularly limited, the cell gap (a separation between the hydrophobic insulating film surface provided to the first substrate, and the second substrate) of the cell of the invention may be appropriately set within a range of, for example, from 3 μm to 100 μm.

The cell surface area of the cell of the invention is preferably within a range of from 100 μm² to 100 cm², more preferably within a range of from 500 μm² to 10 cm², and particularly preferably within a range of from 1000 μm² to 1 cm².

In the invention, the cell interior is preferably filled substantially completely with an oil and a hydrophilic liquid. The volume ratio of the oil to the hydrophilic liquid (oil:hydrophilic liquid) is preferably from 1:1000 to 1:0.1, more preferably from 1:100 to 1:1, and particularly preferably from 1:50 to 1:2.

Image Display Device

The image display device of the invention is provided with a pixel that includes the above-described optical element of the invention, and the oil thereof includes a coloring material.

Since the image display device of the invention is provided with the pixel that includes the above-described optical element of the invention, suppression of deterioration of the hydrophobic insulating film when repeatedly adopting the voltage-on and voltage-off states is enabled, and durability against repeated driving is excellent.

The preferable configuration of the image display device of the invention is as described above.

More specifically, the image display device of the invention may have a configuration in which the liquid crystals in the configurations of known liquid crystal display devices are replaced by the oil and the hydrophilic liquid. Accordingly, driving may be performed similarly to in conventional liquid crystal display devices.

Namely, in addition to the pixels included in the optical element of the invention, the image display device of the invention may be configured provided with members similar to those of known liquid crystal display devices such as a backlight, a cell gap adjusting spacer, or a sealing sealant, if necessary.

When doing so, the oil and the hydrophilic liquid may, for example, be provided by application to a region above the first substrate compartmented by the partitioning wall using an inkjet method.

For the image display device of the invention, examples of methods include a method including: a first substrate preparation process that prepares the first substrate; a process that forms the hydrophobic insulating film to the electroconductive surface side of the first substrate; a partitioning wall forming process that forms the partitioning wall compartmenting a region above the hydrophobic insulating film forming face of the first substrate; a loading process that loads the oil and the hydrophilic liquid in this order to the region compartmented by the partitioning wall (by, for example, an inkjet method); and a cell forming process that, after the loading process, overlays the second substrate to the side of the first substrate to which the oil and the hydrophilic liquid were loaded to form the cell (and if necessary, a cell sealing process that seals the cell by joining the first substrate and the second substrate at the periphery of the cell).

Joining of the first substrate to the second substrate may be performed using a sealant commonly employed in liquid crystal display device production.

A spacer forming process that forms a cell gap adjusting spacer may be performed after the partitioning wall forming process but before the cell forming process.

### EXAMPLES

More specific explanation follows according to examples of the invention; however, as long as the scope of the invention is not exceeded, the invention is not limited to the examples below. Note that unless otherwise stated, “portion” and “%” are mass-based.

### Examples 1 to 18

### Preparation of Curable Compositions A1 to A18

After preparing a 30% solid content solution by dissolving the polymerizable monomers and polymerization initiators of the kinds and the amounts listed in Table 1 and Table 2 in methyl ethyl ketone, 4-hydroxy-2,2,6,6-tetramethylpiperidine-1-oxyl free radical (manufactured by Tokyo Chemical Industry Co., Ltd.), as a polymerization inhibitor, was added so as to be at 200 ppm (0.02%) with respect to the polymerizable monomer content. The obtained solution was filtered using a 0.1 μm tetrafluoroethylene filter, and respective curable compositions A1 to A18 prepared.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| Composition | | A1 | A2 | A3 | A4 | A5 | A6 | A7 | A8 | A9 | A10 |
| Polymerizable | S-(1) | 97 | 70 | 50 | 30 | 50 | | | | | 60 |
| monomer | S-(5) | | | | | | 50 | | | | |
| | S-(6) | | | | | | | 50 | | | |
| | S-(13) | | | | | | | | 50 | | |
| | S-(14) | | | | | | | | | 50 | |
| | S-(16) | | | | | | | | | | |
| | S-(17) | | | | | | | | | | |
| | M-1 | | 27 | 47 | 67 | | | | | | |
| | M-2 | | | | | 47 | 47 | 47 | 47 | 47 | |
| | M-3 | | | | | | | | | | 37 |
| | M-4 | | | | | | | | | | |
| | M-5 | | | | | | | | | | |
| Initiator | P-1 | 3 | 3 | 3 | 3 | | | | | | |
| | P-2 | | | | | 3 | 3 | 3 | 3 | 3 | 3 |

TABLE 2

| | | | | | | | | | | Comp. | Comp. | Comp. |
|---|---|---|---|---|---|---|---|---|---|---|---|---|
| | | Ex. 11 | Ex. 12 | Ex. 13 | Ex. 14 | Ex. 15 | Ex. 16 | Ex. 17 | Ex. 18 | ex. 1 | ex. 2 | ex. 3 |
| Composition | | A11 | A12 | A13 | A14 | A15 | A16 | A17 | A18 | Pr-1 | Pr-2 | Pr-3 |
| Polymerizable | S-(1) | 60 | 60 | 40 | | | | | | | | 70 |
| monomer | S-(5) | | | | | | | | | | | |
| | S-(6) | | | 20 | | | | | | | | |
| | S-(13) | | | | | | | | | | | |
| | S-(14) | | | | | | | | | | | |
| | S-(16) | | | | 50 | | | | | | | |
| | S-(17) | | | | | 97 | 70 | 50 | 20 | | | |
| | M-1 | | | | 47 | | 27 | 47 | 77 | | | 30 |
| | M-2 | | | | | | | | | 97 | | |
| | M-3 | | | | | | | | | | | |
| | M-4 | 37 | | | | | | | | | 97 | |
| | M-5 | | 37 | 37 | | | | | | | | |
| Initiator | P-1 | | | | 3 | 3 | 3 | 3 | 3 | 3 | 3 | |
| | P-2 | 3 | 3 | 3 | | | | | | | | |

Explanation of Tables 1 and 2
The values listed in Table 1 and Table 2 for each component are mass ratios.
Details regarding the polymerizable monomers and initiators listed in Table 1 and Table 2 are as given below.

Polymerizable Monomer
M-1: dipentaerythritol hexaacrylate (trade name: KAYARAD DPHA, manufactured by Nippon Kayaku Co., Ltd.) (a polyfunctional compound)
M-2: pentaerythritol tetraacrylate (trade name: ATMMT, manufactured by Shin-Nakamura Chemical Co., Ltd.) (a polyfunctional compound)
M-3: 2,2,2-trifluoroethylacrylate (trade name: V-3F, manufactured Osaka Organic Chemical Industry Ltd.) (a monofunctional compound)
M-4: stearylacrylate (manufactured by Tokyo Chemical Industry Co., Ltd.) (a monofunctional compound)
M-5: ethylene glycoldiacrylate (manufactured by Aldrich) (a polyfunctional compound)
S-(16): KF-100T (trade name, manufactured by Shin-Etsu Chemical Co., Ltd.)
S-(17): TEGO RAD2010 (trade name, manufactured by Evonik Degussa Japan)

Initiator (Photopolymerization Initiator)
P-1: 2-hydroxy-2-methyl-1-phenyl-1-propane-1-one (manufactured by BASF SE, DAROCUR 1173)
P-2: (2-dimethylamino-2-(4-methylbenzyl)-1-(4-morpholine-4-ylphenyl)butane-1-one (manufactured by BASF SE, trade name: IRGACURE 379EG)

Preparation of Oil

The components in the composition below were mixed to obtain an oil.

The obtained oil was black, and the dynamic viscosity thereof (at 20° C.) was measured using a viscometer and found as 7.9 mPa·s.

The oil is also referred to as “black ink” below.

Oil (Black Ink) Composition

| | |
|---|---|
| Colorant Y1 shown below | 260 mg |
| Colorant M1 shown below | 200 mg |
| Colorant M2 shown below | 160 mg |
| Colorant C1 shown below | 300 mg |
| Colorant C2 shown below | 100 mg |
| n-decane | 4080 mg |

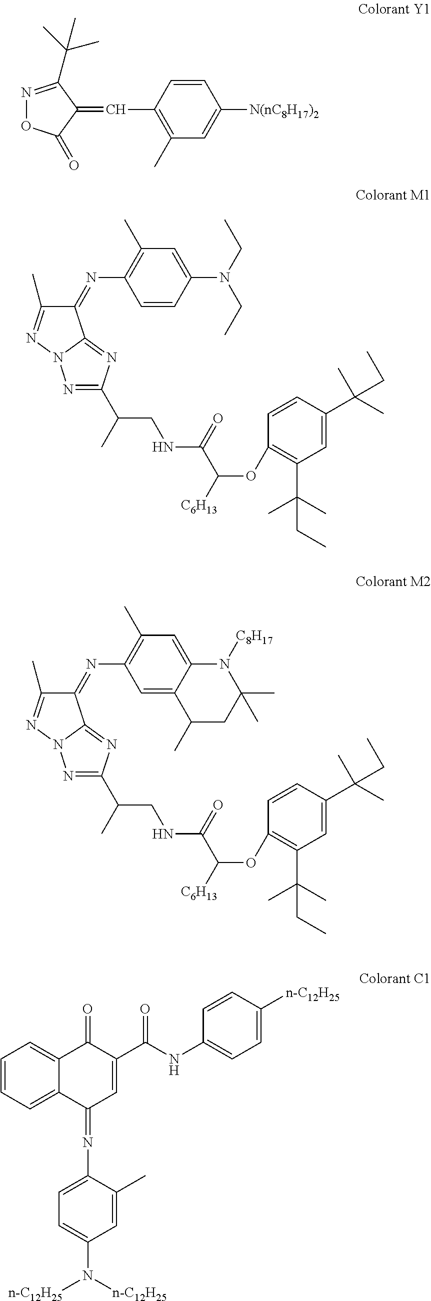

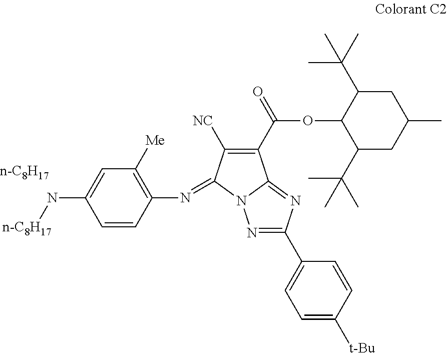

Preparation of Test Cells

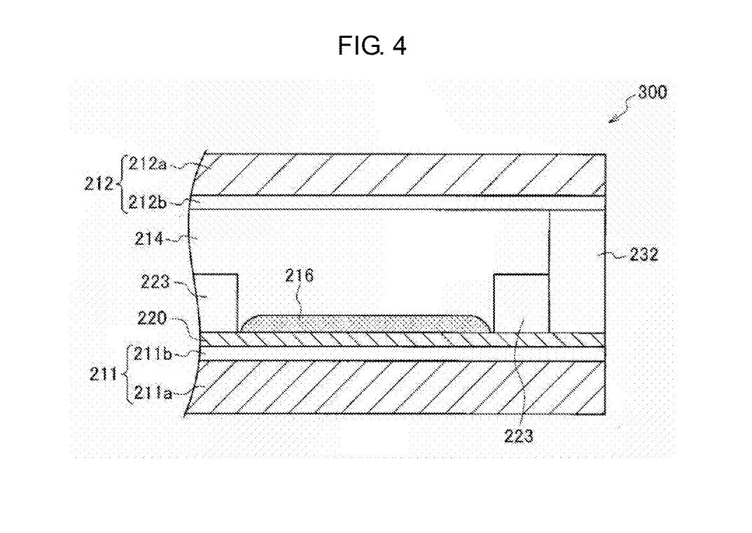

An optical element having the configuration illustrated in FIG. 4 (a test cell 300) was produced as described below.

FIG. 4 is a schematic cross-section diagram of a test cell employed in the present example.

First, a glass substrate 211a (1 cm square) was provided with an indium tin oxide film 211b (ITO film; a transparent electrode) of 100 nm film thickness to prepare a first substrate 211.

On the ITO film 211b on the glass substrate 211a, one out of either one of the curable compositions A1 to A18 obtained as described above and one out of either one of Pr-1 to Pr-3 were applied and a coating layer formed, and subsequently, after a portion of the solvent was dried for 30 seconds in a VCD (a vacuum drying device, manufactured by Tokyo Ohka Kogyo Co., Ltd.) such that the coating layer lost fluidity, a curable composition layer was obtained by prebaking for 3 minutes at 120° C. The polysiloxane compound included in the curable composition layer was made to polymerize by exposing the obtained curable composition layer at an exposure amount of 300 mJ/cm² under a nitrogen atmosphere using an ultra-high pressure mercury lamp, and the curable composition layer thereby cured. Further heating of the curable composition layer after exposure was carried out for 50 minutes at 240° C.

In this manner, a hydrophobic insulating film 220 (crosslinked film; film thickness 100 nm), that included a crosslinked structure deriving from a polysiloxane compound, was formed above the ITO film 211b.

After overlaying a photoresist film (trade name PHOTOCAST, manufactured by Hitachi Chemical Co., Ltd) of 20 μm thickness on the formed hydrophobic insulating film 220, the photoresist film was exposed through a photomask having a lattice pattern (with a lattice size of 200 μm square, and a lattice line width of 20 μm), and a partitioning wall 223 (with height 20 μm, and width 20 μm) was prepared by alkali development.

As a sealant 232, silicon rubber (trade name SIRIUS, manufactured by Fuso Rubber Co., Ltd.), of thickness 40 μm and width 1 mm, was placed at the periphery of the glass substrate after the partitioning wall was formed.

Next, as an oil 216, the oil (black ink) obtained above was injected into the region compartmented by the partitioning wall 223 using an inkjet method so as to give a thickness of 4 μm, and, as a hydrophilic liquid 214, an electrolyte solution (an aqueous NaCl solution having a NaCl concentration of 1 mol/L) was injected thereon to give a thickness of 36 μm.

Onto this, the glass substrate 212a provided with an ITO film 212b (a second substrate 212) was placed such that the ITO film 212b became the hydrophilic liquid 214 (electrolyte) side, and the first substrate 211 provided with the hydrophobic insulating film 220 and the second substrate 212 were fixed by silicon rubber (the sealant 232).

The test cell 300 illustrated in FIG. 4 was prepared as described above.

Evaluation of EWD Driving on a Hydrophobic Water Repellent Film

In the obtained test cell 300 in a state of having voltage non-applied (voltage-off state), black ink (the oil 216) was spread onto the hydrophobic insulating film 220, and a blackened state was produced (FIG. 4).

The transparent electrodes (the ITO film 212b, and the ITO film 211b) at the top and bottom of the test cell 300 were each connected to a signal generator, inspected by eye in a state in which 15V of DC voltage was applied, and evaluated based on the evaluation criteria below.

The evaluation results are listed in Table 3.

Drivability Evaluation Criteria
A: Contraction of the black ink due to voltage application was observed.
B: Slight contraction of the black ink due to voltage application was observed.
C: No change to the shape of the black ink was observed even with voltage application.

The voltage-on/voltage-off cycle (30 second application of the DC voltage, with 30 second intervals (time with no applied voltage)) described above was repeated 500 times.

Then, after the cycle had been repeated 500 times, the black ink (oil 216) was made to contract in the voltage-on state, inspected by eye in this state, and evaluated based on the evaluation criteria below.

The evaluation results are listed in Table 3.

Durability Evaluation Criteria
A: The contracted state of the black ink after the cycle was repeated 500 times was similar to the contracted state of the black ink in the first cycle.
B: The responsiveness of the black ink to the voltage application had greatly deteriorated due to repeating the cycle 500 times, with the black ink barely contracting following the cycle being repeated 500 times.

### Comparative Examples 1 to 3

Comparative Compositions Pr-1 to Pr-3 were prepared in substantially the same manner as the curable composition Al of Example 1, except in that the amounts of polymerizable monomers and polymerization initiators were modified to be as listed in Table 2.

Test cells were prepared in substantially the same manner as that of Example 1, except in that the curable composition A1 of Example 1 was changed to be one of the comparative compositions Pr-1 to Pr-3, and evaluation was carried out in substantially the same manner as for Example 1.

The evaluation results are listed in Table 3.

### Comparative Example 4

A test cell was prepared in substantially the same manner as that of Example 1, except in that the hydrophobic insulating film, prepared using curable composition Al in the preparation of the test cell of Example 1, was changed to a hydrophobic insulating film prepared using TEFLON (registered trademark) AF-1600 manufactured by DuPont. Evaluation was carried out in substantially the same manner as for Example 1. Herein, AF-1600 is an amorphous fluoropolymer not having a crosslinked structure.

The evaluation results are listed in Table 3.

### Comparative Example 5

A test cell was prepared in substantially the same manner as for that of Example 1, except in that the hydrophobic insulating film 220, prepared using the curable composition Al in the preparation of the test cell of Example 1, was changed to a hydrophobic insulating film prepared using CYTOP “CTL-809M” manufactured by Asahi Glass Co., Ltd. Evaluation was carried out in substantially the same manner as for Example 1. Herein, CYTOP is an amorphous fluoropolymer not having a crosslinked structure. The evaluation results are listed in Table 3.

TABLE 3

| | Material of | | |
|---|---|---|---|
| | Hydrophobic | | |
| | insulating film | Drivability | Durability |
| Example 1 | Composition A1 | A | A |
| Example 2 | Composition A2 | A | A |
| Example 3 | Composition A3 | A | A |
| Example 4 | Composition A4 | B | A |
| Example 5 | Composition A5 | A | A |
| Example 6 | Composition A6 | A | A |
| Example 7 | Composition A7 | A | A |
| Example 8 | Composition A8 | A | A |
| Example 9 | Composition A9 | A | A |
| Example 10 | Composition A10 | A | A |
| Example 11 | Composition A11 | A | A |
| Example 12 | Composition A12 | A | A |
| Example 13 | Composition A13 | A | A |
| Example 14 | Composition A14 | A | A |
| Example 15 | Composition A15 | A | A |
| Example 16 | Composition A16 | A | A |
| Example 17 | Composition A17 | A | A |
| Example 18 | Composition A18 | B | A |
| Comparative Example 1 | Composition Pr-1 | C | — |
| Comparative Example 2 | Composition Pr-2 | C | — |
| Comparative Example 3 | Composition Pr-3 | A | B |
| Comparative Example 4 | AF-1600 | A | B |
| Comparative Example 5 | CYTOP | A | B |

As listed in Table 3, compared to the test cells of Comparative Examples 1 to 5, the test cells of Examples 1 to 18 that employed the hydrophobic insulating film that includes a crosslinked structure deriving from the siloxane compound having an unsaturated double bond, had excellent EWD drivability, and excellent durability against repeated driving.

The entire disclosure of Japanese patent application number 2012-197950 is incorporated in the present specification by reference.

All cited documents, patent applications and technical standards mentioned in the present specification are incorporated by reference in the present specification to the same extent as if the individual cited document, patent application, or technical standard was specifically and individually indicated to be incorporated by reference.

What is claimed is:

1. An optical element comprising a cell, the cell comprising:
a first substrate, at least a portion of at least one surface of the first substrate being electroconductive;
a second substrate disposed so as to face the electroconductive surface of the first substrate;
an electrically non-conductive oil and an electroconductive hydrophilic liquid that are provided between the electroconductive surface of the first substrate and the second substrate; and
a hydrophobic insulating film that is provided at at least a portion of the electroconductive surface side of the first substrate, that contacts the oil, and that includes a crosslinked structure derived from a siloxane compound having an unsaturated double bond,
the profile of an interface between the oil and the hydrophilic liquid changing according to a voltage applied across the hydrophilic liquid and the electroconductive surface of the first substrate, and
the siloxane compound being a compound represented by Formula (1): 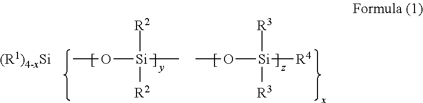
wherein, in Formula (1), each of R¹ to R⁴ independently represents an organic group having from 1 to 20 carbon atoms; at least one selected from the group consisting of R¹, R³, and R⁴ includes an unsaturated double bond, and in cases in which a plurality of any one of R¹ to R⁴ are present, the plurality of any one of R¹ to R⁴ may be the same as or different from one another; x represents an integer that satisfies 1≦x≦4; y represents an integer that satisfies 10≦y≦500; z represents an integer that satisfies 0≦z≦500; and the portion consisting of y units of —OSi(R²)2- and z units of —OSi(R³)2- may be a portion formed by random copolymerization or a portion formed by block copolymerization.

2. The optical element of claim 1, wherein a contact surface area between the oil and the hydrophobic insulating film changes according to the voltage.

3. The optical element of claim 1, wherein the hydrophobic insulating film is formed by curing a curable composition including the siloxane compound and comprises a crosslinked structure that is produced by polymerization of the siloxane compound.

4. The optical element of claim 1, wherein a content of the compound represented by Formula (1) in the curable composition is 30% by mass or greater with respect to a total solid content of the curable composition.

5. An image display device comprising a pixel including the optical element of claim 1, the oil including a coloring material.
